(19) United States
(12) Patent Application Publication
(10) Pub. No.: US 2023/0274198 A1
(43) Pub. Date: Aug. 31, 2023

(54) AUTOMATICALLY IDENTIFYING AN AVAILABLE MEETING ROOM FOR A SPONTANEOUS MEETING

(71) Applicant: Microsoft Technology Licensing, LLC, Redmond, WA (US)

(72) Inventors: Christopher Shingee PARK, Issaquah, WA (US); Victoria Carolina RODRIGUEZ, Seattle, WA (US); Charles Ronald COOK, Bellevue, WA (US); Charles Vincent RICCARDI, III, Los Angeles, CA (US)

(21) Appl. No.: 18/012,494

(22) PCT Filed: Jun. 24, 2021
(86) PCT No.: PCT/US2021/038943

§ 371 Date: Dec. 22, 2022

(30) Foreign Application Priority Data
Jun. 25, 2020 (NL) 2025917

(51) Int. Cl. G06Q 10/02; G06Q 10/1093; G06F 16/2457

(52) U.S. Cl. CPC G06Q 10/02; G06Q 10/1095; G06F 16/24575

(57) ABSTRACT

A computing device can include a spontaneous meeting component that assists the user to quickly and efficiently find a meeting room for a spontaneous meeting. The spontaneous meeting component can find one or more available meeting rooms in response to the user's selection of a user interface element that indicates a request to identify an available meeting room for the spontaneous meeting. Advantageously, the spontaneous meeting component can be configured to automatically identify one or more available meeting rooms, without requiring any additional user input other than the user's selection of the user interface element. The spontaneous meeting component can be configured to determine an estimated current location of the computing device and an estimated duration of the spontaneous meeting. The proposed meeting room can be identified based at least in part on the estimated current location of the computing device and the estimated duration of the spontaneous meeting.

### BACKGROUND

A meeting occurs when two or more people come together for one or more purposes. Meetings occur in many different types of settings, including business and other formal settings. Meetings are an important part of the work day for many people. Although meetings are often conducted in person, advances in computer and communication technology have allowed some meetings to occur virtually.

Meetings are typically scheduled in advance. A common way to schedule meetings involves the use of calendar invitations. Calendar invitations can be used by software programs (e.g., personal information managers) that include email and calendar capabilities. A person who wishes to organize a meeting can send a calendar invitation, via email, to the people whom the organizer wants to participate in the meeting. The calendar invitation can include a proposed date and time for the meeting. The desired meeting participants who are available at the proposed date and time can accept the calendar invitation. When someone accepts the calendar invitation, a calendar event can be automatically created and added to that person's calendar.

Meetings that are held within an enterprise often take place in a designated meeting room, which is sometimes referred to as a conference room. Some enterprises use software that enables users to reserve a meeting room. In some cases such software can be integrated into other software programs, like personal information managers, that enable calendar invitations to be used for scheduling meetings. Someone who is organizing a meeting can reserve a conference room for the meeting at the same time that he or she sends a calendar invitation to schedule the meeting.

### SUMMARY

In accordance with one aspect of the present disclosure, a method is disclosed for assisting a user of a computing device to identify a room for a spontaneous meeting. The method is implemented by the computing device. The method includes detecting the user's selection of a user interface element that indicates a request to identify an available meeting room for the spontaneous meeting. The method also includes determining an estimated current location of the computing device. The method also includes determining an expected duration of the spontaneous meeting. The method also includes causing automatic identification of a proposed meeting room for the spontaneous meeting in response to the user's selection of the user interface element. The automatic identification of the proposed meeting room depends on the estimated current location of the computing device and the expected duration of the spontaneous meeting. The automatic identification of the proposed meeting room does not require any additional user input other than the user's selection of the user interface element. The method also includes causing information about the proposed meeting room to be presented to the user. The method also includes receiving additional user input comprising an indication that the user wants to proceed with a meeting room reservation. The method also includes causing reservation of a meeting room in response to the additional user input.

Determining the estimated current location of the computing device may include retrieving, via a location application programming interface on the computing device, global positioning system (GPS) coordinates of the computing device, as determined by GPS hardware within the computing device. Determining the estimated current location of the computing device may also include using the GPS coordinates to identify a building where the computing device is located.

Determining the expected duration of the spontaneous meeting may include causing a default value for the expected duration of the spontaneous meeting to be presented to the user.

Causing the reservation of the meeting room may include causing the proposed meeting room to be reserved.

The method may further include causing information about at least one other meeting room besides the proposed meeting room to be presented to the user. The additional user input may include a selection by the user of an alternative meeting room that is different from the proposed meeting room. Causing the reservation of the meeting room may include causing the alternative meeting room selected by the user to be reserved.

The proposed meeting room may be currently available and may be scheduled to remain available for the expected duration of the spontaneous meeting.

The method may further include causing automatic creation of a calendar event for the spontaneous meeting. The calendar event may be created on a calendar that is maintained by the user. The calendar event may indicate the meeting room that has been reserved. Causing the reservation of the meeting room may include causing the meeting room to be blocked in order to prevent others from reserving the meeting room.

The method may further include detecting an additional computing device within a predefined distance of the computing device. The additional computing device may be associated with an additional user. The method may further include causing a suggestion to add the additional user to the calendar event to be presented to the user. The method may further include causing the additional user to be added to the calendar event in response to receiving further user input that accepts the suggestion.

Causing the automatic identification of the proposed meeting room may include sending a request to a meeting room service. The request may cause the meeting room service to search a meeting room database for any meeting rooms that satisfy a set of criteria. The request may include the estimated current location of the computing device and the expected duration of the spontaneous meeting. The set of criteria may be based at least in part on the estimated current location of the computing device and the expected duration of the spontaneous meeting.

The request may cause the meeting room service to search the meeting room database for any meeting rooms that are (i) located within a pre-defined radius of the estimated current location of the computing device, (ii) currently available, and (iii) scheduled to remain available for the expected duration of the spontaneous meeting.

The meeting room service may identify a plurality of meeting rooms that satisfy the set of criteria. The meeting room service may select a meeting room from among the plurality of meeting rooms as the proposed meeting room. The method may further include receiving a response from the meeting room service. The response may include information about the selected meeting room.

The meeting room service may select the meeting room that is located closest to the user based on the estimated current location of the computing device.

The meeting room service may identify only one meeting room that satisfies the set of criteria. The method may further include receiving a response from the meeting room service. The response may include information about the meeting room that satisfies the set of criteria.

The meeting room service may not identify any meeting rooms that satisfy the set of criteria. The method may further include receiving a response from the meeting room service. The response may include an indication that no meeting rooms are available.

The method may further include causing at least some data for identifying available meeting rooms to be pre-fetched. Pre-fetching may start before the user input is received.

The method may further include causing information identifying a first building corresponding to the estimated current location of the computing device to be presented to the user, receiving further user input that identifies a second building as a current location of the user, and causing the information identifying the first building to be replaced with information identifying the second building.

Causing the information about the proposed meeting room to be presented to the user may include causing a map of a building that includes the proposed meeting room to be displayed on a display screen of the computing device.

In accordance with another aspect of the present disclosure, a system is disclosed for assisting a user of a computing device to identify a room for a spontaneous meeting. The system includes one or more processors, memory in electronic communication with the one or more processors, and instructions stored in the memory. The instructions may be executable by the one or more processors to detect the user's selection of a user interface element that indicates a request to identify an available meeting room for the spontaneous meeting. The instructions may also be executable by the one or more processors to determine an estimated current location of the computing device, determine an expected duration of the spontaneous meeting, and cause automatic identification of a proposed meeting room for the spontaneous meeting in response to the user's selection of the user interface element. The automatic identification of the proposed meeting room depends on the estimated current location of the computing device and the expected duration of the spontaneous meeting. The automatic identification of the proposed meeting room does not require any additional user input other than the user's selection of the user interface element. The instructions may also be executable by the one or more processors to cause information about the proposed meeting room to be presented to the user, receive additional user input including an indication that the user wants to proceed with a meeting room reservation, and cause reservation of a meeting room in response to the additional user input.

The computing device may include a GPS transceiver and a location application programming interface (API). Determining the estimated current location of the computing device may include using the location API to retrieve global positioning system (GPS) coordinates of the computing device as determined by the GPS transceiver and using the GPS coordinates to identify a building where the computing device is located.

The system may further include additional instructions that are executable by the one or more processors to send a request to a meeting room service. The request may cause the meeting room service to search a meeting room database for any meeting rooms that satisfy a set of criteria. The request may include the estimated current location of the computing device and the expected duration of the spontaneous meeting. The set of criteria may be based at least in part on the estimated current location of the computing device and the expected duration of the spontaneous meeting.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIGS. 1A and 1B illustrate an example of a system in which the techniques disclosed herein can be utilized.

FIG. 2 illustrates an example of a method for assisting a user of a computing device to identify a room for a spontaneous meeting, which can be implemented by the spontaneous meeting component in the system of FIGS. 1A-B.

FIG. 3 illustrates another example of a method for assisting a user of a computing device to identify a room for a spontaneous meeting, which can be implemented by the meeting room service in the system of FIGS. 1A-B.

FIG. 4 illustrates an example of a method for pre-fetching data for identifying a proposed meeting room.

FIGS. 5A-D illustrate examples of some possible outcomes that can occur when a meeting room database is searched for any meeting rooms that satisfy a set of criteria.

FIGS. 6A-D illustrate various aspects of an example of a user interface for a spontaneous meeting component.

FIG. 7 illustrates certain components that can be included within a computing device.

### DETAILED DESCRIPTION

As noted above, the present disclosure is generally related to the scheduling of meetings. Under some circumstances, people may need to meet relatively spontaneously. For example, one person may drop by another person's office or cubicle and ask whether the other person is available for a brief meeting. When two or more people want to have a spontaneous meeting, they may have difficulty finding a meeting room for the meeting. The meeting participants may walk around the building where they are located and try to find an available meeting room, or they may use meeting room scheduling software to try to reserve a meeting room if one is available. Neither of these approaches is a particularly effective way to quickly find a meeting room. People are generally busy, and meeting participants may not have a lot of time available for a spontaneous meeting. If it takes a long time to find a meeting room, this can interfere with meeting participants' other appointments or commitments. Accordingly, benefits may be realized by techniques for assisting people to quickly and efficiently find a meeting room for a spontaneous meeting.

In accordance with the present disclosure, a computing device can be equipped with a component that is configured to assist the user to quickly and efficiently find a meeting room for a spontaneous meeting. This type of component may be referred to herein as a spontaneous meeting component. When a user of the computing device wants to have a spontaneous meeting with one or more other people, the spontaneous meeting component can automatically find a meeting room that is currently available or that is going to be available in the near future. As an example, the term “spontaneous meeting” can refer to a meeting that has not been scheduled in advance, and that should begin at the present time (or at least as soon as possible once a meeting room has been found).

A spontaneous meeting can arise without any advance planning. In the context of the present disclosure, a spontaneous meeting can be different from an impromptu conversation among a group of people. An impromptu conversation can occur anywhere. With a spontaneous meeting, however, there can be a desire to meet together in a meeting room (e.g., for the sake of privacy). For example, someone may stop by a business colleague's desk and ask to discuss a current project. After a few minutes of talking, they might decide that it would be more appropriate to discuss the project in a meeting room.

In some cases, a spontaneous meeting can be planned in advance, but someone may have forgotten to schedule a meeting room. For example, suppose that a group of people generally meets at a regularly scheduled time (e.g., the first Thursday of the month at noon), but no one scheduled a meeting room for this month's meeting. Shortly before noon, one or more members of the group may realize that they need to find a meeting room for the meeting. This can be considered to be a kind of spontaneous meeting in accordance with the present disclosure.

In each of the examples discussed above, because a meeting room has not been scheduled in advance, a group of people that want to have a spontaneous meeting can have difficulty finding a meeting room that is available.

A spontaneous meeting component as disclosed herein can be configured to find one or more available meeting rooms in response to the user's selection of a user interface element that indicates a request to identify an available meeting room for the spontaneous meeting (e.g., a button that says “Meet Now” or a similar message). Advantageously, the spontaneous meeting component can be configured to automatically identify one or more available meeting rooms, without requiring any additional user input other than the user's selection of the user interface element. In other words, the spontaneous meeting component can be configured to automatically find available meeting rooms in response to a single user action. Thus, the user is not required to go through the typical process of reserving a meeting room, which would require the user to input various pieces of information (e.g., date, start time, end time). Instead, the user can simply select an appropriate user interface element (e.g., a “Meet Now” button) and information about available meeting rooms can be automatically presented to the user in response. This simplifies and streamlines the process of finding available meeting rooms, which can be especially important in the case of a spontaneous meeting. If a group of people want to have a spontaneous meeting, they typically want to meet as soon as possible. They do not want to spend a great deal of time finding a meeting room. A spontaneous meeting component as disclosed herein enables people to quickly and efficiently find a meeting room so that they can begin their spontaneous meeting as soon as possible and not have to spend time wandering around a building in search of a meeting room or reserving a meeting room through the typical process.

In some embodiments, the spontaneous meeting component can be configured to determine an estimated current location of the computing device, and to identify a proposed meeting room based at least in part on the estimated current location of the computing device. For example, the spontaneous meeting component can be configured to determine what building the computing device is located in, and to identify what meeting rooms are currently available (or will be available in the near future) in that building.

The spontaneous meeting component can be configured to identify a proposed meeting room based at least in part on the estimated current location of the computing device. The identification of the proposed meeting room can also be based at least in part on an expected duration of the spontaneous meeting. For example, if the spontaneous meeting is expected to last 30 minutes, the spontaneous meeting component can try to find a meeting room that is located near the estimated current location of the computing device, currently available, and scheduled to remain available for at least the next 30 minutes. In some embodiments, a default value for the expected duration of the spontaneous meeting can be presented to the user, and the user can either accept the default value or specify a different value.

In some situations, the spontaneous meeting component may be able to identify a plurality of potential meeting rooms for a spontaneous meeting. The spontaneous meeting component can select one of the potential meeting rooms (e.g., a meeting room that is currently available and that is closest to the estimated current location of the computing device) as the proposed meeting room and present that meeting room to the user as the default option. However, the spontaneous meeting component can also indicate to the user that there are other potential meeting rooms that are available. If the user wishes to proceed with reserving a meeting room for the spontaneous meeting, the user can either accept the default option or select another meeting room based on the information that is presented.

Under some circumstances, the spontaneous meeting component may not be able to identify any meeting rooms that have all of the desired characteristics. In this case, the spontaneous meeting component can try to identify one or more meeting rooms that come as close as possible to having the desired characteristics. For example, even if no meeting rooms are currently available, the spontaneous meeting component might be able to identify a meeting room that is available soon and that has the other desired characteristics. The spontaneous meeting component can select the meeting room that comes closest to having the desired characteristics as a proposed meeting room. If the spontaneous meeting component is able to identify one or more other potential meeting rooms that come close to having the desired characteristics, the spontaneous meeting component can also indicate that to the user as well.

As noted above, once a proposed meeting room (and possibly one or more other potential meeting rooms) has been presented to the user, the user can either accept the proposed meeting room or select another meeting room. The user can also provide additional user input confirming that the user wants to proceed with a meeting room reservation. In response to receiving such additional user input, the spontaneous meeting component can reserve the meeting room.

The spontaneous meeting component can also automatically create a calendar event for the spontaneous meeting. The calendar event can be created on a calendar that is maintained by the user. In some embodiments, the spontaneous meeting component can be included as part of another software program (such as a personal information manager) that includes a calendar, and the calendar event can be created on the calendar that is maintained by that software program.

The calendar event can indicate the meeting room that has been reserved for the spontaneous meeting. In addition, the calendar event can also include other information that can be detected about the spontaneous meeting. For example, under some circumstances the people who are going to participate in the spontaneous meeting could be standing in relatively close proximity to one another while one of them uses a spontaneous meeting component on his or her computing device to try to find a meeting room for the spontaneous meeting. In some embodiments, the spontaneous meeting component can be configured to detect the other meeting participants who are standing in close proximity to the user and (after user confirmation) add the names of the people who have been detected to the calendar event that has been created for the spontaneous meeting. By doing this, the calendar event can include a record of (at least some of) the people who participated in the meeting.

The spontaneous meeting component can be configured to communicate with one or more external entities in connection with implementing the techniques disclosed herein. In some embodiments, the spontaneous meeting component can communicate with a meeting room service, which can be configured to maintain information about available meeting rooms in the building where the user is located (and possibly one or more other nearby buildings as well). The spontaneous meeting component and the meeting room service can work together to identify available meeting rooms for the spontaneous meeting and to reserve a meeting room if the user decides to proceed.

In some embodiments, the spontaneous meeting component can be configured to pre-fetch at least some data for identifying available meeting rooms. This pre-fetching can occur before the spontaneous meeting component receives user input specifically requesting a proposed meeting room for a spontaneous meeting. Pre-fetching the data can improve the responsiveness of the spontaneous meeting component, so that the spontaneous meeting component can present information about available meeting rooms soon after the user requests such information.

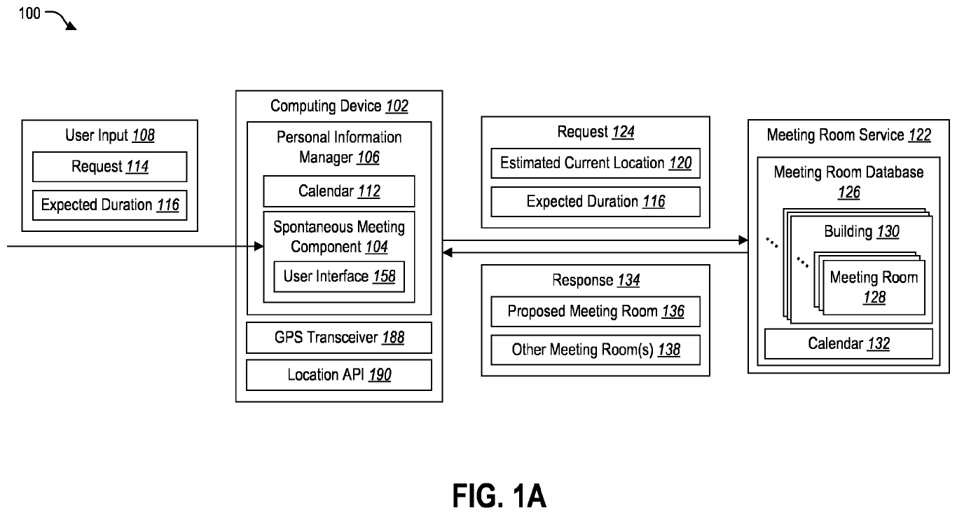

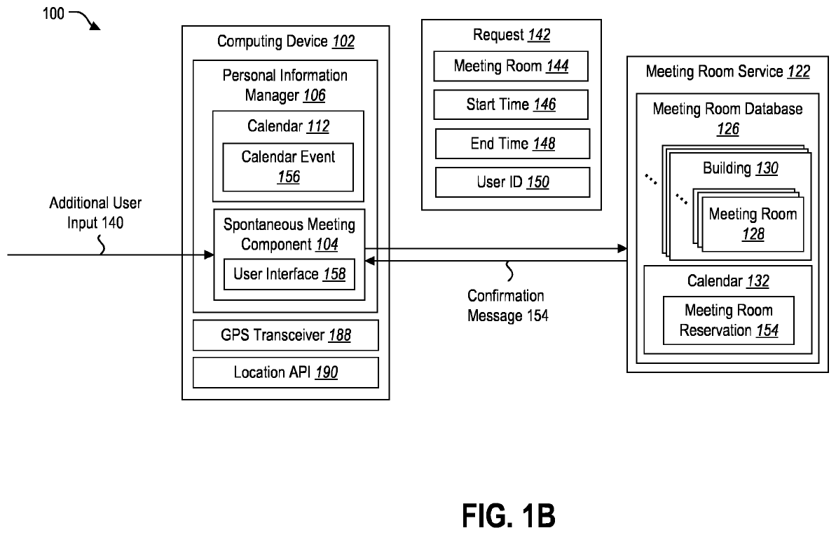

FIGS. 1A and 1B illustrate an example of a system 100 in which the techniques disclosed herein can be utilized. Referring initially to FIG. 1A, the system 100 includes a computing device 102, which can be any electronic equipment that includes memory and a processor that is configured to follow instructions stored in the memory to perform sequences of mathematical and logical operations. Some examples of computing devices 102 that can be used in connection with the disclosed embodiments include laptop computers, mobile devices (e.g., smartphones), tablet computers, desktop computers, smartwatches, virtual reality headsets, and the like.

The computing device 102 includes a spontaneous meeting component 104. In the depicted example, the spontaneous meeting component 104 is included within a software program, such as a personal information manager 106, that is running on the computing device 102. In an alternative embodiment, the spontaneous meeting component 104 can be a self-contained component (e.g., a standalone application or process).

The personal information manager 106 can be a type of application software that functions as a personal organizer. The personal information manager 106 can facilitate the recording, tracking, and management of certain types of information about a person's life. The personal information manager 106 can include a calendar 112 as well as other components such as an email client, a contacts manager, a tasks manager, note-taking functionality, and the like. For simplicity, only the calendar 112 is shown in FIG. 1.

The spontaneous meeting component 104 is configured to assist a user of a computing device 102 to quickly and efficiently identify a room for a spontaneous meeting. When a user of the computing device 102 wants to have a spontaneous meeting with one or more other people, the spontaneous meeting component 104 can automatically find a meeting room that is currently available or that is going to be available in the near future.

The spontaneous meeting component 104 can include a user interface 158. A user of the computing device 102 can interact with the spontaneous meeting component 104 via the user interface 158. In some embodiments, the user interface 158 of the spontaneous meeting component 104 can be integrated with the user interface of the personal information manager 106.

The computing device 102 includes a global positioning system (GPS) transceiver 188, which is configured to determine the location of the computing device 102 and to represent that location in terms of GPS coordinates. The computing device 102 also includes a location application programming interface (API) 190, which allows other components on the computing device 102 (such as the spontaneous meeting component 104) to access the current location of the computing device 102 as determined by the GPS transceiver 188.

In some embodiments, the spontaneous meeting component 104 can communicate with one or more external entities in connection with identifying the potential meeting room(s). For example, in the depicted system 100 the spontaneous meeting component 104 is shown communicating with a meeting room service 122. In some embodiments, the meeting room service 122 can be maintained by an enterprise to which the user of the computing device 102 and at least some of the other individuals who are going to participate in the spontaneous meeting belong. The meeting room service 122 can be implemented across one or more computing devices (e.g., servers).

The meeting room service 122 can be configured to maintain a meeting room database 126. The meeting room database 126 can include a calendar 132 that can be used for reserving the meeting rooms 128 in one or more buildings 130. For a particular meeting room 128, the calendar 132 can indicate the times when that meeting room 128 has been reserved, and the times when that meeting room 128 has not been reserved and is available for use.

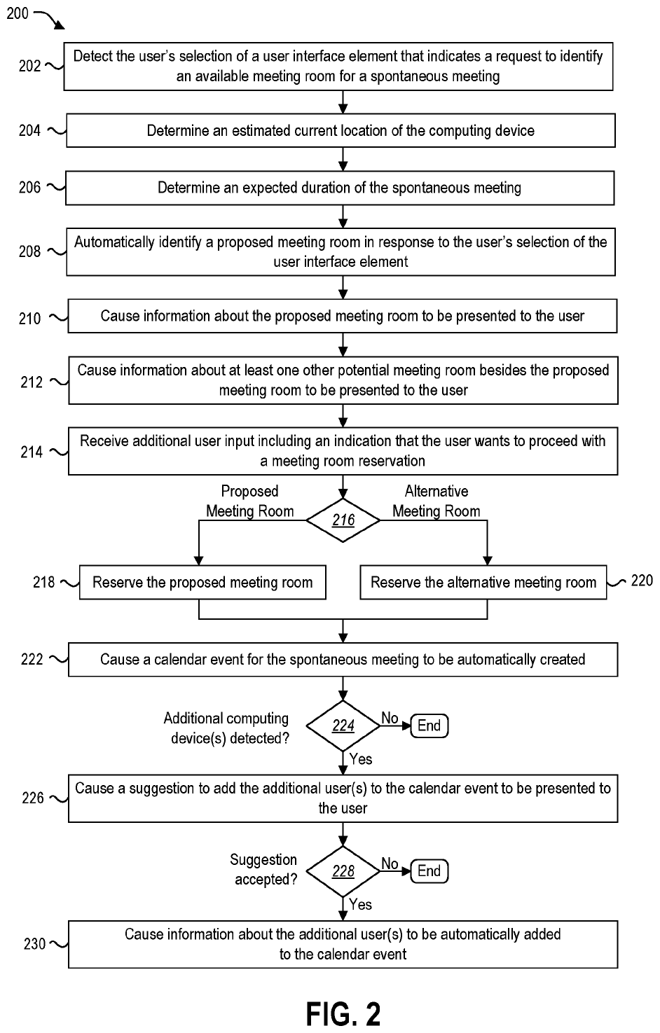

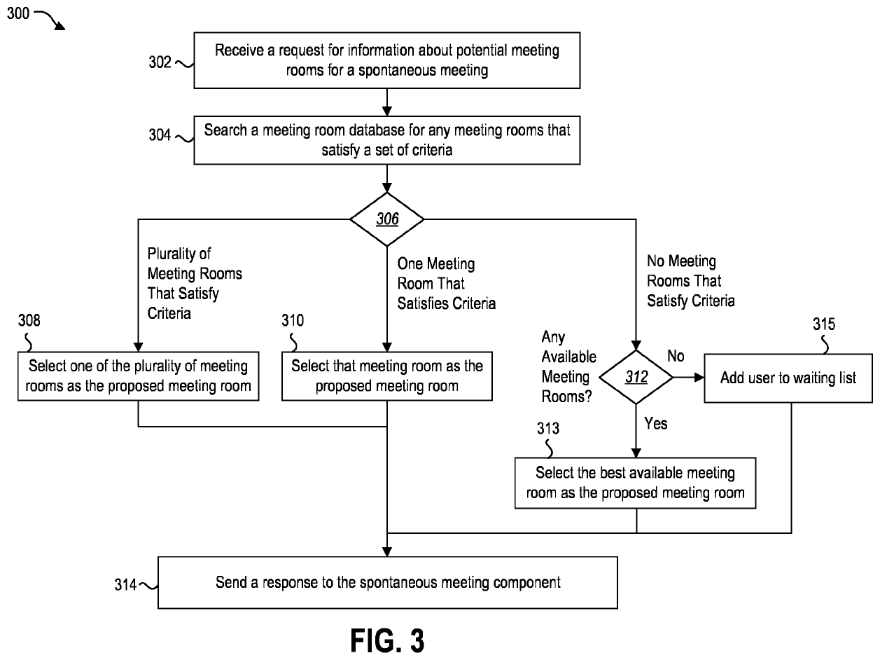

FIG. 1A shows various actions involving the spontaneous meeting component 104 and/or the meeting room service 122. For example, FIG. 1A shows the spontaneous meeting component 104 receiving user input 108. The user input 108 can include a request 114 to identify an available meeting room for a spontaneous meeting. The user input 108 can also include an expected duration 116 for the spontaneous meeting. FIG. 1A also shows the spontaneous meeting component 104 sending a request 124 to the meeting room service 122. The request 124 can include the estimated current location 120 of the computing device 102 and the expected duration 116 of the spontaneous meeting. FIG. 1A also shows the meeting room service 122 sending a response 134 to the spontaneous meeting component 104. The response 134 can include information about one or more potential meeting rooms for the spontaneous meeting. For example, the response 134 can identify a proposed meeting room 136. The response 134 can also include information about one or more other potential meeting rooms 138. These actions will be discussed in greater detail below in connection with the methods 200, 300 that are shown in FIGS. 2 and 3.

FIG. 1B shows additional actions involving the spontaneous meeting component 104 and/or the meeting room service 122. For example, FIG. 1B shows the spontaneous meeting component 104 receiving additional user input 140. FIG. 1B also shows the spontaneous meeting component 104 sending another request 142 to the meeting room service 122. The request 142 can be to reserve a particular meeting room 144. The request 142 can include an indication of the start time 146 and the end time 148 for the reservation of the meeting room 144. The request 142 can also include a user identifier (ID) 150 that is associated with the user of the computing device 102. FIG. 1B also shows the meeting room service 122 sending a confirmation message 152 back to the spontaneous meeting component 104. FIG. 1B also shows a meeting room reservation 154 added to the calendar 132 that is maintained by the meeting room database 126. FIG. 1B also shows a calendar event 156 added to the calendar 112 of the personal information manager 106. These actions will be discussed in greater detail below in connection with the methods 200, 300 that are shown in FIGS. 2 and 3.

FIG. 2 illustrates an example of a method 200 for assisting a user of a computing device 102 to identify a room for a spontaneous meeting. The method 200 will be described in relation to the system 100 shown in FIGS. 1A-B. The method 200 can be implemented by a spontaneous meeting component 104 that is running on the computing device 102.

The method 200 can include detecting 202 the user's selection of a user interface element that indicates a request 114 to identify an available meeting room for the spontaneous meeting. For example, in some embodiments the method 200 can include detecting the user's selection of a button that says “Meet Now” (or that includes a similar message).

In response to detecting 202 the user's selection of a user interface element that indicates a request 114 to identify an available meeting room for the spontaneous meeting, the spontaneous meeting component 104 can determine 204 the estimated current location 120 of the computing device 102. In some embodiments, determining 204 the estimated current location 120 of the computing device 102 can include determining GPS coordinates of the computing device 102, and then using the GPS coordinates to determine the identity of the building where the computing device 102 is located. In some embodiments, the spontaneous meeting component 104 can use the location API 190 on the computing device 102 to retrieve the GPS coordinates of the computing device 102, as determined by the GPS transceiver 188 within the computing device 102. The spontaneous meeting component 104 can then send the GPS coordinates to the meeting room service 122, which can use the GPS coordinates to determine the identity of the building where the computing device 102 is located (e.g., by querying a database, such as the meeting room database 126, that includes location information about buildings 130) and return that information to the spontaneous meeting component 104. Alternatively, in some embodiments the spontaneous meeting component 104 can itself use the GPS coordinates to determine the identity of the building where the computing device 102 is located.

The method 200 can also include determining 206 an expected duration 116 for the spontaneous meeting. In some embodiments, a default value for the expected duration 116 for the spontaneous meeting can be presented to the user. The user can either accept the default value or select a different value. As one example, the user interface 158 of the spontaneous meeting component 104 can include a user interface element that includes a plurality of different icons corresponding to different lengths of time (e.g., 30 minutes, 45 minutes, one hour, two hours). One of these icons can be pre-selected as a default option. The user can either accept the default value (by doing nothing) or specify a different value for the expected duration 116 of the spontaneous meeting (by selecting a different icon other than the pre-selected icon).

The method 200 can also include automatically identifying 208 a proposed meeting room 136 for the spontaneous meeting in response to the user's selection 202 of the user interface element. Advantageously, the identification of the proposed meeting room does not require any additional user input other than the user's selection 202 of the user interface element.

The identification 208 of the proposed meeting room 136 for the spontaneous meeting can be based at least in part on the estimated current location 120 of the computing device 102 and the expected duration 116 of the spontaneous meeting. Some examples showing how the proposed meeting room 136 can be identified 208 will be described below.

As an example, the term “automatically” can refer to an action that is performed by a computing device without any additional user input or control other than what is specifically described. Thus, as an example, automatically identifying 208 a proposed meeting room 136 for the spontaneous meeting in response to the user's selection 202 of the user interface element can mean that the spontaneous meeting component 104 running on the computing device 102 is able to identify 208 a proposed meeting room 136 for the spontaneous meeting without any additional user input or control other than the user's selection 202 of the user interface element that indicates a request 114 to identify an available meeting room for the spontaneous meeting.

As noted above, a default value for the expected duration 116 for the spontaneous meeting can be presented to the user, and the user can either accept the default value or select a different value. Thus, under some circumstances, the user can provide additional input beyond the selection of a user interface element that indicates a request 114 to identify an available meeting room for a spontaneous meeting. However, such additional user input is not required for the spontaneous meeting component 104 to identify 208 a proposed meeting room 136 for the spontaneous meeting. Even if the user does not do anything other than select 202 the user interface element that indicates a request 114 to identify an available meeting room for a spontaneous meeting, the spontaneous meeting component 104 can automatically identify 208 a proposed meeting room 136 for the spontaneous meeting.

In some embodiments, identifying 208 a proposed meeting room 136 for the spontaneous meeting can include sending one or more requests 124 to the meeting room service 122. For example, in some embodiments the spontaneous meeting component 104 can send a request 124 to the meeting room service 122 that includes the estimated current location 120 of the computing device 102 and the expected duration 116 of the spontaneous meeting. The meeting room service 122 can use this information to search the meeting room database 126 for potential meeting rooms. Based on results of the searching, the meeting room service 122 can identify a proposed meeting room 136 and one or more other potential meeting rooms 138 and send a response 134 to the spontaneous meeting component 104 that includes this information.

In some embodiments, the meeting room service 122 can be configured to simply search for meeting room availability based on specific parameters, and return information about available meeting rooms that are identified (if any) without necessarily identifying a proposed meeting room 136. The spontaneous meeting component 104 can then identify a proposed meeting room 136 and one or more other potential meeting rooms 138 based on the information that is received from the meeting room service 122.

In some embodiments, the spontaneous meeting component 104 can be configured to identify 208 a proposed meeting room 136 for the spontaneous meeting without communicating with the meeting room service 122 or another similar service. For example, in some embodiments the spontaneous meeting component 104 can be configured to query a meeting room database directly.

In some embodiments, the spontaneous meeting component 104 may send a plurality of requests 124 to the meeting room service 122 and receive a plurality of responses 134 from the meeting room service 122 in connection with identifying 208 a proposed meeting room 136 for the spontaneous meeting. For example, the spontaneous meeting component 104 could send a request 124 for meeting room availability during a particular time interval. If the meeting room service 122 sends a response 134 indicating that no meeting rooms are available during that time interval, the spontaneous meeting component 104 could then send another request 124 for meeting room availability during a later time interval. This process could be repeated until at least one available meeting room is found or until it is determined that no meeting rooms are available during any time intervals that would be relevant to the user.

Once a proposed meeting room 136 (and possibly one or more other potential meeting rooms 138) have been identified 208, the method 200 can include causing 210 information about the proposed meeting room 136 to be presented to the user of the computing device 102. The method 200 can also include causing 212 information about at least one other potential meeting room 138 besides the proposed meeting room 136 to be presented to the user of the computing device 102. For example, the spontaneous meeting component 104 can cause information about the proposed meeting room 136 and possibly one or more other potential meeting rooms 138 to be displayed on a display screen of the computing device 102. As another example, the spontaneous meeting component 104 can cause information about the proposed meeting room 136 and possibly one or more other potential meeting rooms 138 to be spoken to the user of the computing device 102 via a text-to-speech system on the computing device 102.

If the user decides to proceed, the method 200 can include receiving 214 additional user input 140 that includes an indication that the user wants to proceed with reserving a meeting room. In some embodiments, the user can provide the additional user input 140 by selecting a user interface element that confirms the user's intention to reserve the meeting room (e.g., a checkmark or another similar icon).

The user can either accept the proposed meeting room 136 or choose one of the other potential meeting rooms 138. The method 200 can include determining 216 whether the proposed meeting room 136 or another one of the potential meeting rooms 138 has been selected by the user. If the user chooses to accept the proposed meeting room 136, the user may not need to take any additional action besides providing the additional user input 140 indicating that the user wants to proceed with reserving a meeting room. If the user decides to choose one of the other potential meeting rooms 138, the additional user input 140 can include a selection of another potential meeting room 138 (different from the proposed meeting room 136) that the user would like to reserve.

If it is determined 216 that the user has accepted the proposed meeting room 136, the method 200 can include reserving 218 the proposed meeting room 136. On the other hand, if it is determined 216 that the user has selected one of the other potential meeting rooms 138, the method 200 can include reserving 220 the alternative meeting room 138 that has been selected by the user. In either case, the spontaneous meeting component 104 can send a request 142 to the meeting room service 122 to reserve the meeting room that has been selected by the user. The request 142 can include an indication of the selected meeting room 144. The request 142 can also include an indication of the start time 146 and the end time 148 for the meeting room reservation. The request 142 can also include a user ID 150 that is associated with the user of the computing device 102. Reserving a meeting room (either the proposed meeting room 136 or an alternative meeting room 138) can include reserving the meeting room within the meeting room database 126. This can include blocking the meeting room so that no one else is permitted to reserve the meeting room.

In some embodiments, the calendar 132 that is maintained by the meeting room service 122 can be designed in such a way that meeting rooms 128 are reserved in particular time intervals (e.g., 15-minute time intervals, 30-minute time intervals). In such embodiments, the start time 146 for the meeting room reservation can be selected as the current time (if the selected meeting room 144 is currently available) or the time at which the selected meeting room 144 will become available (if the selected meeting room 144 is not currently available). The end time 148 for the meeting room reservation can be the earliest permitted time that allows the meeting room to be reserved for the expected duration 116 of the spontaneous meeting.

For example, suppose that the calendar 132 is designed to accommodate meeting room reservations in 15-minute increments. In other words, suppose that the end time 148 of a meeting room reservation is restricted to x:00, x:15, x:30, or x:45, where “x” represents the hour. Further suppose that the current time is 3:10 p.m., the meeting room 144 selected by the user is currently available, and the expected duration 116 of the spontaneous meeting is 30 minutes. In this case, the request 142 could indicate a start time 146 of 3:10 p.m., corresponding to the current time. The request 142 could also indicate an end time 148 of 3:45 p.m., because that is the earliest permitted time that allows the meeting room to be reserved for the expected duration 116 of the spontaneous meeting (which is 30 minutes in this example).

As another example, suppose that the calendar 132 is designed with the same restrictions as in the previous example, the current time is 3:10 p.m., the meeting room 144 selected by the user is not currently available but will be available at 3:15 p.m., and the expected duration 116 of the spontaneous meeting is 45 minutes. In this case, the request 142 could indicate a start time 146 of 3:15 p.m., because that is the time at which the selected meeting room 144 will become available. The request 142 could indicate an end time 148 of 4:00 p.m., because that is the earliest permitted time that allows the meeting room to be reserved for the expected duration 116 of the spontaneous meeting (which is 45 minutes in this example).

In some embodiments, the calendar 132 that is maintained by the meeting room service 122 can be designed to permit a request 142 to reserve a meeting room 144 to specify any desired start time 146 and any desired end time 148. In other words, in some embodiments the calendar 132 may not be restricted to specific time increments in the manner described above. In such embodiments, the start time 146 for the meeting room reservation could be the current time (if the selected meeting room 144 is currently available) or the time at which the selected meeting room 144 will become available (if the selected meeting room 144 is not currently available). The end time 148 for the meeting room reservation could be determined by adding the expected duration 116 of the spontaneous meeting to the start time 146.

For example, suppose that the current time is 3:10 p.m., the meeting room 144 selected by the user is currently available, and the expected duration 116 of the spontaneous meeting is 30 minutes. In this case, the request 142 could indicate a start time 146 of 3:10 p.m. and an end time 148 of 3:40 p.m.

In response to receiving the request 142, the meeting room service 122 can reserve the selected meeting room 144 on the calendar 132 from the start time 146 to the end time 148 (assuming that the meeting room 144 is still available during this time when the request 142 is received). FIG. 1B shows a reservation 154 having been added to the calendar 132. The reservation 154 can be associated with the user ID 150 that is specified in the request 142. Once the reservation 154 has been made, the meeting room service 122 can send a confirmation message 152 to the spontaneous meeting component 104.

The method 200 can also include causing 222 a calendar event 156 for the spontaneous meeting to be automatically created. The calendar event 156 can be added to a calendar 112 that is maintained by the user of the computing device 102. The calendar event 156 can indicate the meeting room 144 that has been reserved for the spontaneous meeting as well as the start time 146 and the end time 148 for the reservation 154 of the meeting room 144. In some embodiments, the spontaneous meeting component 104 can cause 222 the calendar event 156 to be created in response to receiving the additional user input 140 that includes an indication that the user wants to proceed with reserving a meeting room. Alternatively, in some embodiments the spontaneous meeting component 104 can cause 222 the calendar event 156 to be created in response to receiving the confirmation message 152 from the meeting room service 122 indicating that the reservation 154 has been made.

In some situations, a plurality of people who are going to participate in the spontaneous meeting could be standing in relatively close proximity to one another while one of them uses a spontaneous meeting component 104 on his or her computing device 102 to try to find a meeting room for the spontaneous meeting. In this kind of situation, information about other people who are going to be participating in the spontaneous meeting can be automatically added to the calendar event 156 that is created for the spontaneous meeting.

For example, in some embodiments the spontaneous meeting component 104 running on a particular computing device 102 can be configured to detect 224 any other computing devices that are located within a predefined distance of the computing device 102. In response to detecting 224 one or more additional computing devices, the spontaneous meeting component 104 can cause 226 a suggestion to add the user(s) of the additional computing device(s) to the calendar event 156 to be presented to the user of the computing device 102. For example, the spontaneous meeting component 104 can cause the suggestion to be displayed on a display screen of the computing device 102. As another example, the spontaneous meeting component 104 can cause the suggestion to be spoken to the user of the computing device 102 via a text-to-speech system on the computing device 102. If it is determined 228 that the user accepts the suggestion (via additional user input 140, for example), then the method 200 can include causing 230 information about the user(s) of the additional computing device(s) to be automatically added to the calendar event 156.

FIG. 3 illustrates another example of a method 300 for assisting a user of a computing device 102 to identify a room for a spontaneous meeting. The method 300 will be described in relation to the system 100 shown in FIGS. 1A-B. In some embodiments, some or all of the method 300 can be implemented by the meeting room service 122 in the system 100 shown in FIGS. 1A-B. Alternatively, in some embodiments, some or all of the method 300 can be implemented by the spontaneous meeting component 104 on the computing device 102.

The method 300 can include receiving 302 a request 124 for information about potential meeting rooms for a spontaneous meeting. The request 124 can be received 302 from a spontaneous meeting component 104 running on a computing device 102. The request 124 can include the estimated current location 120 of the computing device 102 and the expected duration 116 of the spontaneous meeting.

In response to receiving the request 124, the meeting room service 122 can search 304 the meeting room database 126 for any meeting rooms 128 that satisfy a set of criteria. The set of criteria can be based at least in part on the estimated current location 120 of the computing device 102 and the expected duration 116 of the spontaneous meeting. For example, the meeting room service 122 can search the meeting room database 126 for any meeting rooms 128 that are (i) located near the estimated current location 120 of the computing device 102, (ii) currently available, and (iii) scheduled to remain available for the expected duration 116 of the spontaneous meeting. With respect to (i), in some embodiments the meeting room service 122 can search the meeting room database 126 for any meeting rooms 128 that are located within the same building 130 as the computing device 102 (based on the estimated current location 120 of the computing device 102). Alternatively, in some embodiments the meeting room service 122 can search the meeting room database 126 for any meeting rooms 128 that are located within a predefined distance of the computing device 102 (based on the estimated current location 120 of the computing device 102).

The method 300 can also include evaluating 306 the results of searching the meeting room database 126. There are at least three possible outcomes for the results of searching the meeting room database 126. A first possible outcome is that the meeting room service 122 identifies a plurality of meeting rooms 128 that satisfy the set of criteria on which the search is based (e.g., criteria (i), (ii), and (iii) described above). In this case, the meeting room service 122 can select 308 one of the plurality of meeting rooms 128 as the proposed meeting room 136. The selection of the proposed meeting room 136 can be based on an evaluation of which of the plurality of meeting rooms 128 most closely matches the set of criteria on which the search is based. For example, in some embodiments the meeting room service 122 can select the meeting room 128 that is located closest to the computing device 102 (based on the estimated current location 120 of the computing device 102) as the proposed meeting room 136. As another example, in some embodiments the meeting room service 122 can select the meeting room 128 that has particular characteristics (e.g., size, videoconferencing capability), which can be specified by the user.

A second possible outcome is that the meeting room service 122 identifies only one meeting room 128 that satisfies the set of criteria on which the search is based (e.g., criteria (i), (ii), and (iii) described above). In this case, the meeting room service 122 can select 310 that meeting room 128 as the proposed meeting room 136.

A third possible outcome is that the meeting room service 122 is unable to identify any meeting rooms 128 that satisfy the set of criteria on which the search is based (e.g., criteria (i), (ii), and (iii) described above). In this case, the meeting room service 122 can determine 312 whether there are any meeting rooms 128 available at all. In other words, if the meeting room service 122 is unable to identify any meeting rooms 128 that satisfy the set of criteria described above, the meeting room service 122 can then search for any available meeting rooms 128 without restricting the search based on those criteria.

If the meeting room service 122 identifies 312 one or more available meeting rooms 128, the meeting room service 122 can then select 313 the best available meeting room 128 as the proposed meeting room 136. The selection of the best available meeting room 128 can be based on which meeting room 128 comes closest to satisfying the set of criteria.

If, however, the meeting room service 122 is unable to identify 312 one or more available meeting rooms 128, the meeting room service 122 can then add 315 the user to a waiting list. The meeting room service 122 can also cause the user to be notified when the user has moved to the top of the waiting list and a meeting room 128 becomes available for the user.

The method 300 can also include sending 314 a response 134 to the spontaneous meeting component 104. If the meeting room service 122 has selected a proposed meeting room 136, the response 134 can include information about the proposed meeting room 136. The response 134 can also include information about one or more other potential meeting rooms 138.

In some embodiments, the meeting room service 122 can rank the potential meeting rooms 138 based on how closely they correspond to the set of criteria on which the search is based. The N highest ranked potential meeting rooms 138 can be included in the response 134 that is sent to the spontaneous meeting component 104 (where the value of N can be a configurable parameter).

If the meeting room service 122 has not been able to identify a proposed meeting room 136 (e.g., because no meeting rooms 128 are available), the meeting room service 122 can send 314 a response 134 to the spontaneous meeting component 104 indicating that no meeting rooms 128 are available. The response 134 can also indicate that the user has been added to a waiting list, if applicable.

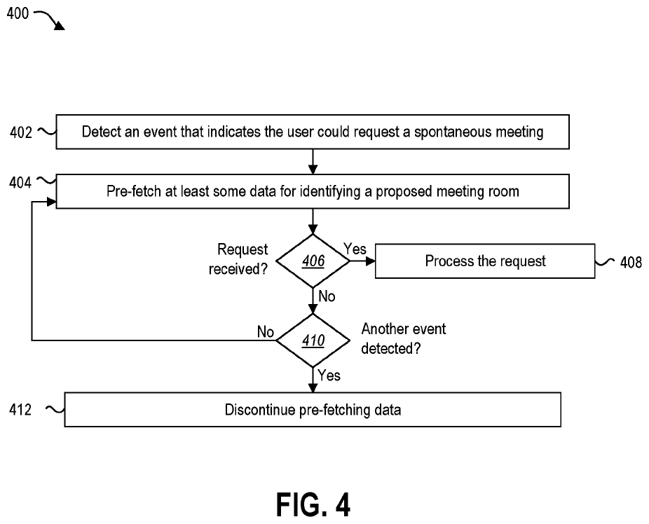

FIG. 4 illustrates an example of a method 400 for pre-fetching data for identifying a proposed meeting room. The method 200 will be described in relation to the system 100 shown in FIGS. 1A-B. The method 200 can be implemented by a spontaneous meeting component 104 that is running on a computing device 102.

The method 400 includes detecting 402 an event that indicates the user could request a spontaneous meeting. An example of such an event could be the user's selection of a user interface element that initiates the process of adding a calendar event to the user's calendar 112. In response to detecting 402 such an event, the method 400 can include pre-fetching 404 at least some data for identifying a proposed meeting room 136 for a spontaneous meeting. This pre-fetching 404 can occur before the spontaneous meeting component 104 receives user input 108 specifically requesting a proposed meeting room 136 for a spontaneous meeting. In some embodiments, pre-fetching 404 can include determining 204 the estimated current location 120 of the computing device 102. In addition, pre-fetching 404 can also include identifying one or more meeting rooms that are currently available near (e.g., in the same building as) the estimated current location 120 of the computing device 102.

If user input 108 including a request 114 to identify an available meeting room for a spontaneous meeting is received 406, then the method can include processing 408 the request in the manner described above in connection with the method 200 shown in FIG. 2. On the other hand, if another event is detected 410 that indicates it is unlikely the user will request a spontaneous meeting, the method 400 can include discontinuing 412 the pre-fetching of the data. An example of such an event would be the user's selection of a user interface element that navigates to a different part of the personal information manager 106 other than the calendar 112 (e.g., the email client).

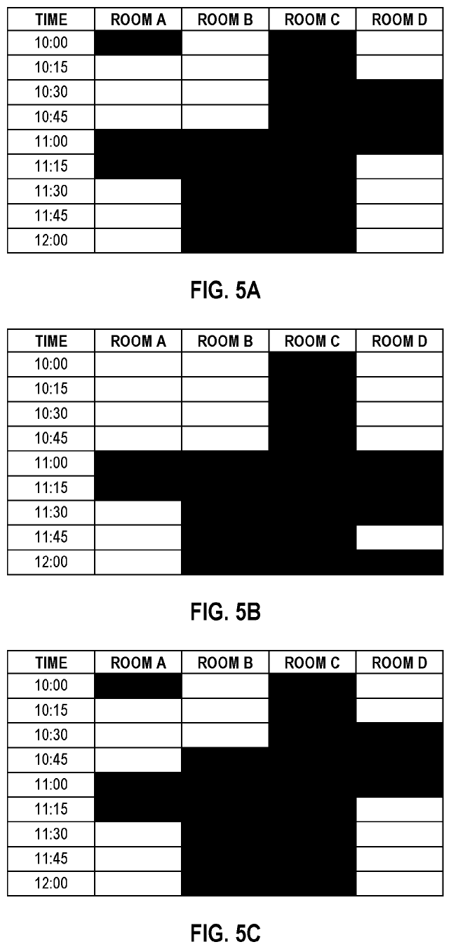

FIGS. 5A-D illustrate examples of some possible outcomes that can occur when the meeting room service 122 searches a meeting room database 126 for any meeting rooms 128 that satisfy a set of criteria. For the sake of simplicity, it will be assumed that there are four possible meeting rooms in these examples. These meeting rooms will be referred to as room A, room B, room C, and room D. It will also be assumed that each of these meeting rooms is located near the computing device 102 that is being used to find a meeting room. It will also be assumed that the current time is 10:10 a.m., and that the user wants to have a spontaneous meeting that is expected to last 30 minutes.

FIG. 5A illustrates an example in which room A is reserved from 10:00-10:15 a.m. and from 11:00-11:30 a.m., room B is reserved from 11:00 a.m. until 12:15 p.m., room C is reserved from 10:00 a.m. until 12:15 p.m., and room D is reserved from 10:30-11:15 a.m. When the meeting room service 122 searches the meeting room database 126 at 10:10 a.m., only room B satisfies the desired criteria (i.e., room B is currently available and is scheduled to remain available for the expected duration 116 of the spontaneous meeting). Therefore, room B can be selected as the proposed meeting room 136. However, the meeting room service 122 might also send information to the spontaneous meeting component 104 about room A and room D, since these meeting rooms come fairly close to satisfying the desired criteria. Room A is not currently available but will be available soon. Room D is currently available and will be available for most of the expected duration 116 of the spontaneous meeting.

FIG. 5B illustrates an example in which room A is reserved from 11:00-11:30 a.m., room B is reserved from 11:00 a.m. until 12:15 p.m., room C is reserved from 10:00 a.m. until 12:15 p.m., and room D is reserved from 11:00-11:45 a.m. In this example, when the meeting room service 122 searches the meeting room database 126 at 10:10 a.m., there are a plurality of meeting rooms that satisfy the desired criteria. In particular, room A, room B, and room D are currently available and are scheduled to remain available for the expected duration 116 of the spontaneous meeting. In this case, the meeting room service 122 can select one of these meeting rooms as the proposed meeting room 136. The selection of the proposed meeting room 136 can be based on an evaluation of which of these meeting rooms most closely matches the desired criteria (e.g., the meeting room 128 that is located closest to the computing device 102, or that has particular desired characteristics). In addition to sending information to the spontaneous meeting component 104 about the meeting room that is selected as the proposed meeting room 136, the meeting room service 122 might also send information to the spontaneous meeting component 104 about the other meeting rooms that satisfy the desired criteria. For example, if room A is selected as the proposed meeting room 136, the meeting room service 122 might also send information to the spontaneous meeting component 104 about room B and room D.

FIG. 5C illustrates an example in which room A is reserved from 10:00-10:15 a.m. and 11:00-11:30 a.m., room B is reserved from 10:45 a.m. until 12:15 p.m., room C is reserved from 10:00 a.m. until 12:15 p.m., and room D is reserved from 10:30-11:15 a.m. When the meeting room service 122 searches the meeting room database 126 at 10:10 a.m., there are not any meeting rooms that satisfy all of the desired criteria. In other words, there are not any meeting rooms that are currently available and that are scheduled to remain available for the expected duration 116 of the spontaneous meeting. In this case, the meeting room service 122 can select the best available meeting room as the proposed meeting room 136. The selection of the best available meeting room 128 can be based on which meeting room comes closest to satisfying the desired criteria. For example, even though room A is not currently available, it will be available soon (at 10:15 a.m., which is just five minutes from the current time of 10:10 a.m.) and it is scheduled to remain available for the expected duration 116 of the spontaneous meeting. Therefore, the meeting room service 122 could select room A as the proposed meeting room 136. The meeting room service 122 might also send information to the spontaneous meeting component 104 about other meeting rooms (e.g., room B and room D) that are reasonably close to satisfying the desired criteria.

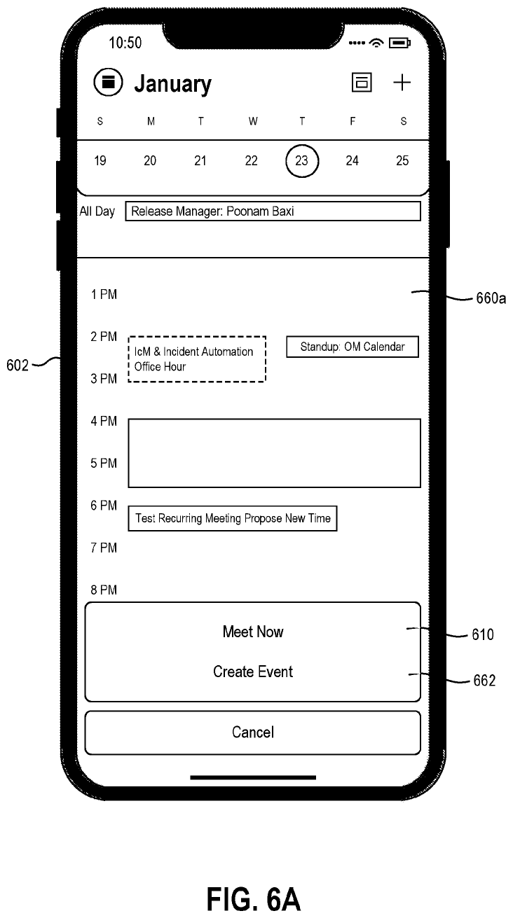

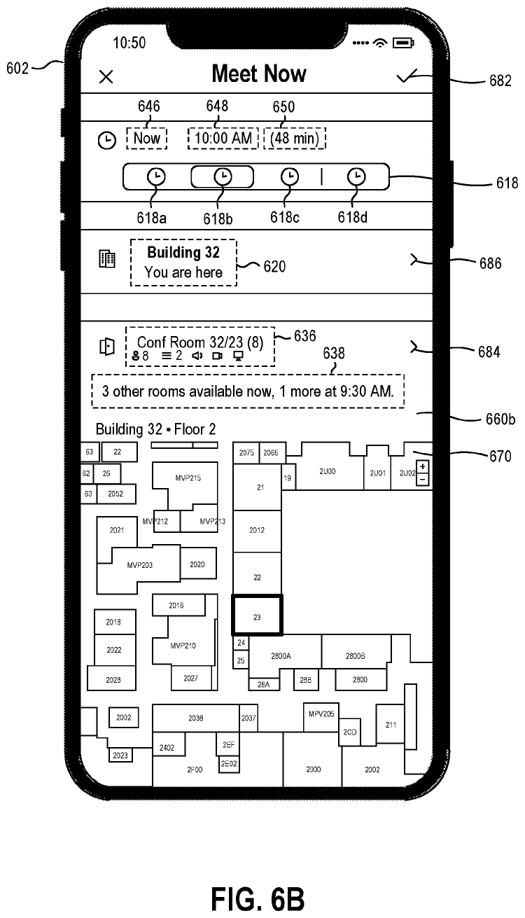

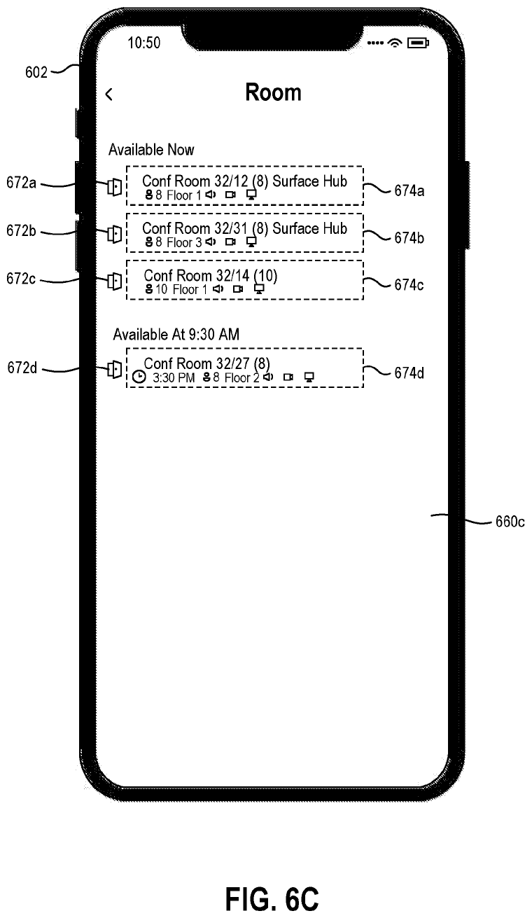

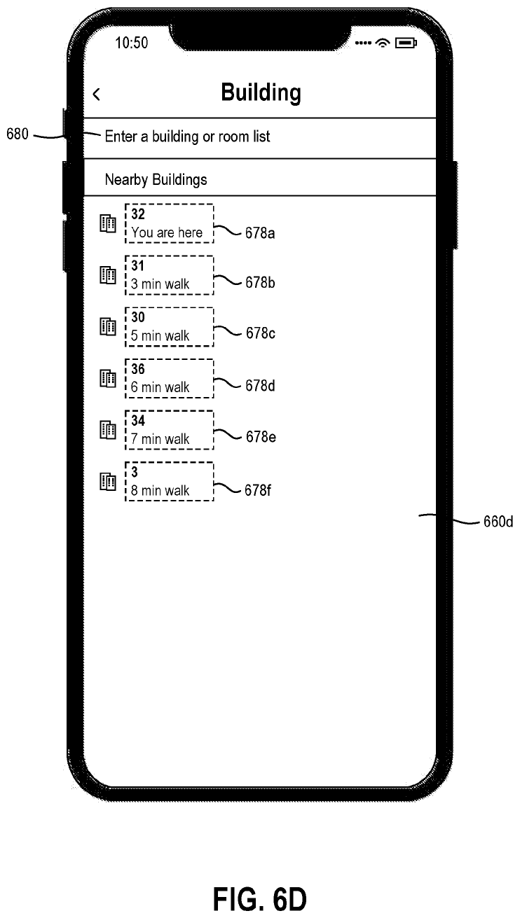

FIGS. 6A-D illustrate various aspects of an example of a user interface 158 for a spontaneous meeting component 104. The example shown in FIGS. 6A-D will be described in relation to the system 100 shown in FIGS. 1A-B. It will be assumed that the user interface 158 of the spontaneous meeting component 104 is integrated within the user interface of a personal information manager 106 that is running on a computing device 102. In the example shown in FIGS. 6A-D, the computing device 102 takes the form of a mobile device 602 (e.g., a smartphone).

FIG. 6A shows a user interface screen 660a that can be displayed by a personal information manager 106. The user interface screen 660a includes a button 610 that says “Meet Now.” The Meet Now button 610 is an example of a user interface element that the user can select in order to submit a request 114 to identify an available meeting room for a spontaneous meeting. As discussed above, in some embodiments the spontaneous meeting component 104 can be configured to automatically identify one or more available meeting rooms in response to the user's selection of a user interface element such as the Meet Now button 610.

In some embodiments, the Meet Now button 610 can be automatically displayed in response to the user's selection of another UI element within the user interface of the personal information manager 106, such as a UI element that initiates the process of adding a calendar event to the user's calendar 112. In such embodiments, another UI element (e.g., a button 662 that says “Create Event”) can also be displayed that enables the user to add an event to the user's calendar 112.

FIG. 6B shows a user interface screen 660b that can be displayed in response to detecting the user's selection of the Meet Now button 610. The user interface screen 660b includes an example of a user interface element 618 that can be used to specify the expected duration 116 of a spontaneous meeting. In the depicted example, the user interface element 618 includes a plurality of different icons 618a-d corresponding to different lengths of time. For example, the smallest icon 618a could represent 30 minutes, the next larger icon 618b could represent 45 minutes, the next larger icon 618c could represent one hour, and the largest icon 618d could represent two hours. In some embodiments, a user can provide input 108 regarding the expected duration 116 for the spontaneous meeting by selecting one of the icons 618a-d. In some embodiments, one of the icons 618a-d can be pre-selected as a default option. For example, in FIG. 6B the icon 618b corresponding to 45 minutes is pre-selected as a default option. The user can either accept this default value for the expected duration 116 of the spontaneous meeting or select a different icon corresponding to a different value.

The user interface screen 660b also includes the start time 646 and the end time 648 of the meeting room reservation, as well as the length of time 650 of the meeting room reservation. In the present example, it will be assumed that the current time is 9:12 a.m. (as indicated in the upper left corner of the display screen of the mobile device 602). It will also be assumed that the end time of a meeting room reservation is restricted to x:00, x:15, x:30, or x:45, where “x” represents the hour. It will also be assumed that there is at least one meeting room that is currently available (as will be discussed in greater detail below). Thus, the start time 646 is represented as “Now.” The end time 648 is represented as 10:00 a.m., because that is the earliest permitted time that allows the meeting room to be reserved for the expected duration 116 of the spontaneous meeting (which, as noted previously, is 45 minutes in this example).

The user interface screen 660b also indicates the estimated current location 620 of the mobile device 602. In the depicted example, the estimated current location 620 includes an estimate of the building where the mobile device 602 is located. As discussed above, the spontaneous meeting component 104 can determine the estimated current location 620 of the mobile device 602 in response to user input 108 that causes the spontaneous meeting component 104 to begin searching for potential meeting rooms.

The user interface screen 660b also indicates a proposed meeting room 636 for the spontaneous meeting. In the depicted example, the proposed meeting room 636 is located in the building where the user is currently located (as inferred based on the estimated current location 620 of the mobile device 602). Information about the proposed meeting room 636 is displayed, such as the capacity of the proposed meeting room 636 and what audiovisual equipment the proposed meeting room 636 has (e.g., whether the proposed meeting room 636 has videoconferencing capability). The user interface screen 660b also includes a map 670 of the building where the proposed meeting room 636 is located, in order to assist the user to find the proposed meeting room 636 in the building.

The user interface screen 660b also includes information 638 about other potential meeting rooms, including several additional potential meeting rooms that are currently available and one additional potential meeting room that is available in the near future. In some embodiments, the spontaneous meeting component 104 can display the information about the proposed meeting room 636 and the information 638 about additional potential meeting rooms when the spontaneous meeting component 104 receives a response 134 from the meeting room service 122.

The user interface screen 660b also includes a user interface element 682 that can be selected to indicate that the user wants to proceed with reserving a meeting room. If the user selects this user interface element 682, the spontaneous meeting component 104 can proceed with reserving the meeting room that has been selected by the user, either by accepting the proposed meeting room 636 or by selecting an alternative meeting room based on the information 638 that is displayed about other potential meeting rooms. The meeting room can be reserved from the indicated start time 646 to the indicated end time 648.

As indicated above, the user can either accept the proposed meeting room 636 or choose another meeting room based on the information 638 that is displayed. If the user decides to choose one of the other potential meeting rooms, the user can select the user interface element 684 near the proposed meeting room 636. This causes another user interface screen 660c to be displayed, as shown in FIG. 6C.

The user interface screen 660c shown in FIG. 6C includes information 674a-d about other potential meeting rooms for the spontaneous meeting. In the depicted example, some of the other potential meeting rooms are currently available, while one potential meeting room will be available in the near future. In order to change the meeting room from the proposed meeting room 636 to another meeting room, the user can select a user interface element (from among the plurality of user interface elements 672a-d shown in the user interface screen 660c) corresponding to the desired meeting room.

As noted above, the user interface screen 660b shown in FIG. 6B indicates the estimated current location 620 of the mobile device 602. Under some circumstances, the estimated current location 620 of the mobile device 602 can be incorrect. There are many different reasons why this could occur. For example, the GPS coordinates provided by the GPS transceiver in the mobile device 602 could be inaccurate (e.g., due to weather conditions such as overcast skies), thereby causing the meeting room service 122 to identify the wrong building (especially if there are a plurality of different buildings located close together). In some embodiments, the spontaneous meeting component 104 can be configured so that the user can modify the estimated current location 620 of the mobile device 602. For example, the user could be permitted to modify the building that is identified as the estimated current location 620.

In some embodiments, the user's selection of the user interface element 686 near the estimated current location 620 of the mobile device 602 causes another user interface screen 660d (which is shown in FIG. 6D) to be displayed. The user interface screen 660d shown in FIG. 6D includes information 678a-f about a plurality of buildings that are close (e.g., within a predefined radius of) the estimated current location 620 of the mobile device 602. If the building that is identified as the estimated current location 620 of the mobile device 602 is incorrect, the user can select a different building from the displayed list (or enter another building via the user interface element 680 at the top of the user interface screen 660d). Even if the building that is identified as the estimated current location 620 of the mobile device 602 is correct, the user might still want to select a different building for the spontaneous meeting. For example, the user might want the spontaneous meeting to occur in a building that is different from the building where the user is currently located.

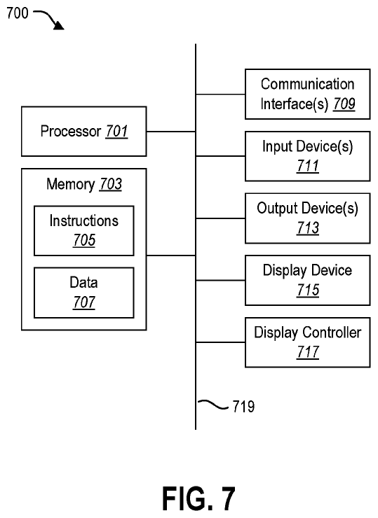

Reference is now made to FIG. 7. One or more computing devices 700 can be used to implement at least some aspects of the techniques disclosed herein. FIG. 7 illustrates certain components that can be included within a computing device 700.

The computing device 700 includes a processor 701 and memory 703 in electronic communication with the processor 701. Instructions 705 and data 707 can be stored in the memory 703. The instructions 705 can be executable by the processor 701 to implement some or all of the methods, steps, operations, actions, or other functionality that is disclosed herein. Executing the instructions 705 can involve the use of the data 707 that is stored in the memory 703. Unless otherwise specified, any of the various examples of modules and components described herein can be implemented, partially or wholly, as instructions 705 stored in memory 703 and executed by the processor 701. Any of the various examples of data described herein can be among the data 707 that is stored in memory 703 and used during execution of the instructions 705 by the processor 701.

Although just a single processor 701 is shown in the computing device 700 of FIG. 7, in an alternative configuration, a combination of processors (e.g., an ARM and DSP) could be used.

The computing device 700 can also include one or more communication interfaces 709 for communicating with other electronic devices. The communication interface(s) 709 can be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing device 700 can also include one or more input devices 711 and one or more output devices 713. Some examples of input devices 711 include a keyboard, mouse, microphone, remote control device, button, joystick, trackball, touchpad, and lightpen. One specific type of output device 713 that is typically included in a computing device 700 is a display device 715. Display devices 715 used with embodiments disclosed herein can utilize any suitable image projection technology, such as liquid crystal display (LCD), light-emitting diode (LED), gas plasma, electroluminescence, or the like. A display controller 717 can also be provided, for converting data 707 stored in the memory 703 into text, graphics, and/or moving images (as appropriate) shown on the display device 715. The computing device 700 can also include other types of output devices 713, such as a speaker, a printer, etc.

The various components of the computing device 700 can be coupled together by one or more buses, which can include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1-18. (canceled)

19. A method for assisting a user of a computing device to identify a room for a spontaneous meeting, the method being implemented by the computing device, the method comprising:
detecting a user selection of a user interface element that indicates a request to identify an available meeting room for the spontaneous meeting;
determining an estimated current location of the computing device;
determining an expected duration of the spontaneous meeting;
causing automatic identification of a proposed meeting room for the spontaneous meeting in response to the user selection of the user interface element, wherein the automatic identification of the proposed meeting room depends on the estimated current location of the computing device and the expected duration of the spontaneous meeting, and wherein the automatic identification of the proposed meeting room does not require any additional user input other than the user selection of the user interface element;
causing information about the proposed meeting room to be presented to the user;
receiving additional user input comprising an indication that the user wants to proceed with a meeting room reservation; and
causing reservation of a meeting room in response to the additional user input.

20. The method of claim 19, wherein determining the estimated current location of the computing device comprises:
retrieving, via a location application programming interface on the computing device, global positioning system (GPS) coordinates of the computing device, as determined by GPS hardware within the computing device; and
using the GPS coordinates to identify a building where the computing device is located.

21. The method of claim 19, wherein determining the expected duration of the spontaneous meeting comprises causing a default value for the expected duration of the spontaneous meeting to be presented to the user.

22. The method of claim 19, wherein causing the reservation of the meeting room comprises causing the proposed meeting room to be reserved.

23. The method of claim 19, wherein:
the method further comprises causing information about at least one other meeting room besides the proposed meeting room to be presented to the user;
the additional user input comprises a selection by the user of an alternative meeting room that is different from the proposed meeting room; and
causing the reservation of the meeting room comprises causing the alternative meeting room selected by the user to be reserved.

24. The method of claim 19, wherein the proposed meeting room is currently available and is scheduled to remain available for the expected duration of the spontaneous meeting.

25. The method of claim 19, wherein:
the method further comprises causing automatic creation of a calendar event for the spontaneous meeting, the calendar event being created on a calendar that is maintained by the user, the calendar event indicating the meeting room that has been reserved; and
causing the reservation of the meeting room comprises causing the meeting room to be blocked in order to prevent others from reserving the meeting room.

26. The method of claim 25, further comprising:
detecting an additional computing device within a predefined distance of the computing device, the additional computing device being associated with an additional user;
causing a suggestion to add the additional user to the calendar event to be presented to the user; and
causing the additional user to be added to the calendar event in response to receiving further user input that accepts the suggestion.

27. The method of claim 19, wherein:
causing the automatic identification of the proposed meeting room comprises sending a request to a meeting room service, wherein the request causes the meeting room service to search a meeting room database for any meeting rooms that satisfy a set of criteria;
the request comprises the estimated current location of the computing device and the expected duration of the spontaneous meeting; and
the set of criteria are based at least in part on the estimated current location of the computing device and the expected duration of the spontaneous meeting.

28. The method of claim 27, wherein the request causes the meeting room service to search the meeting room database for any meeting rooms that are (i) located within a pre-defined radius of the estimated current location of the computing device, (ii) currently available, and (iii) scheduled to remain available for the expected duration of the spontaneous meeting.

29. The method of claim 28, wherein the meeting room service selects the meeting room that is located closest to the user based on the estimated current location of the computing device.

30. The method of claim 27, wherein:
the meeting room service identifies a plurality of meeting rooms that satisfy the set of criteria;
the meeting room service selects a meeting room from among the plurality of meeting rooms as the proposed meeting room; and
the method further comprises receiving a response from the meeting room service, the response comprising information about the selected meeting room.

31. The method of claim 27, wherein:
the meeting room service identifies only one meeting room that satisfies the set of criteria; and
the method further comprises receiving a response from the meeting room service, the response comprising information about the meeting room that satisfies the set of criteria.

32. The method of claim 27, wherein:
the meeting room service does not identify any meeting rooms that satisfy the set of criteria; and
the method further comprises receiving a response from the meeting room service, the response comprising an indication that no meeting rooms are available.

33. The method of claim 19, further comprising causing at least some data for identifying available meeting rooms to be pre-fetched, wherein pre-fetching starts before the user input is received.

34. The method of claim 19, further comprising:
causing information identifying a first building corresponding to the estimated current location of the computing device to be presented to the user;
receiving further user input that identifies a second building as a current location of the user; and
causing the information identifying the first building to be replaced with information identifying the second building.

35. The method of claim 19, wherein causing the information about the proposed meeting room to be presented to the user comprises causing a map of a building that comprises the proposed meeting room to be displayed on a display screen of the computing device.

36. A system for assisting a user of a computing device to identify a room for a spontaneous meeting, comprising:
one or more processors;
memory in electronic communication with the one or more processors; and
instructions stored in the memory, the instructions being executable by the one or more processors to:
detect a user selection of a user interface element that indicates a request to identify an available meeting room for the spontaneous meeting;
determine an estimated current location of the computing device;
determine an expected duration of the spontaneous meeting;
cause automatic identification of a proposed meeting room for the spontaneous meeting in response to the user selection of the user interface element, wherein the automatic identification of the proposed meeting room depends on the estimated current location of the computing device and the expected duration of the spontaneous meeting, and wherein the automatic identification of the proposed meeting room does not require any additional user input other than the user selection of the user interface element;
cause information about the proposed meeting room to be presented to the user;
receive additional user input comprising an indication that the user wants to proceed with a meeting room reservation; and
cause reservation of a meeting room in response to the additional user input.

37. The system of claim 36, wherein the computing device comprises a GPS transceiver and a location application programming interface (API), and wherein determining the estimated current location of the computing device comprises:
using the location API to retrieve global positioning system (GPS) coordinates of the computing device as determined by the GPS transceiver; and
using the GPS coordinates to identify a building where the computing device is located.

38. The system of claim 36, wherein:
the system further comprises additional instructions that are executable by the one or more processors to send a request to a meeting room service, wherein the request causes the meeting room service to search a meeting room database for any meeting rooms that satisfy a set of criteria;
the request comprises the estimated current location of the computing device and the expected duration of the spontaneous meeting; and
the set of criteria are based at least in part on the estimated current location of the computing device and the expected duration of the spontaneous meeting.
